(19) United States
(12) Patent Application Publication
(10) Pub. No.: US 2006/0095614 A1
(43) Pub. Date: May 4, 2006

(54) Device for directly playing audio and video CD

(76) Inventor: Tsung-Yung Hung, Taipei (TW)

Correspondence Address: LIN & ASSOCIATES INTELLECTUAL PROPERTY, P.O. BOX 2339, SARATOGA, CA, 95070-0339, US

(21) Appl. No.: 10/978,274

(22) Filed: Oct. 30, 2004

(51) Int. Cl. G06F 13/38

(52) U.S. Cl. 710/62

(57) ABSTRACT

A device for directly playing audio and video CDs is provided so that a notebook computer could become a portable audio and video CD player. The device operates without powering on the notebook computer. During its operation, the device's audio and video processing circuit, along with the notebook computer's LCD display, speakers, and laser disk drive, draws their required electrical power from the notebook computer's power source. A decoding chip in the device's audio and video processing circuit accesses the content of the audio or video CD, decodes it, and plays it out on the LCD display and speaker of the notebook computer.

### BACKGROUND OF THE INVENTION

1. Field of the Invention

The present invention generally relates to audio and video playing devices and, more particularly, to the audio and video playing devices for turning a notebook computer into a portable audio and video player.

2. The Prior Arts

Recently notebook computers have become popular consumer electronics devices, especially for those users of which mobility is a necessity. With the appropriate operating system support and audio and video (AV) playing programs, a user could easily play the AV CD in the notebook computer's laser disk drive. The notebook computer has become, in some sense, a portable AV player.

To play the AV CDs, the notebook computer has to be powered on, the operating system has to be booted up, and a playing program has to be activated. Compared with TV sets and other home appliances, the foregoing process is rather time consuming, especially when the user simply wants to watch or listen to the AV CDs without using other application programs. For notebook computers usually equipped with a battery of limited supply of electrical power, booting up the entire system for only playing AV CDs results in unnecessary waste of electrical power.

### SUMMARY OF THE INVENTION

Accordingly, an objective of the present invention is to provide a device for directly playing a notebook computer's AV CDs without powering on the notebook computer, making the notebook computer a portable AV player of low power consumption.

Another objective of the present invention is to provide a device for directly playing a notebook computer's AV CDs without powering on the notebook computer so that the AV CDs could be played conveniently and immediately.

Still another objective of the present invention is to provide a device for directly playing a notebook computer's AV CDs that can be operated easily with a remote control. Yet another objective of the present invention is to provide a device for directly playing a notebook computer's AV CDs that can be operated easily with control buttons in a control panel. One additional objective of the present invention is to provide a device for directly playing a notebook computer's AV CDs whose operation status is shown in a display in the control panel for better user friendliness.

Based on the foregoing objectives, a device for directly playing AV CDs is provided so that a notebook computer could become a portable AV CD player. The device operates without powering on the notebook computer. During its operation, the device's AV processing circuit, along with the notebook computer's LCD display, speaker, and laser disk drive, draws their required electrical power from the notebook computer's power source. A decoding chip in the device's AV processing circuit accesses the content of the audio or video CD, decodes it, and plays it out on the LCD display and speaker of the notebook computer.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic view of a preferred embodiment of the present invention.

FIG. 2 is a schematic view of a remote control of a preferred embodiment of the present invention.

FIG. 3 is a schematic view of a control panel of a preferred embodiment of the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

In general, the present invention installs a number of additional components inside a notebook computer, along with the notebook computer's existing components, to turn the notebook computer into a portable AV player. The device of the present invention is therefore not of a single element, but composed of a number of components, some of which are additionally added and some are existing in the notebook computer.

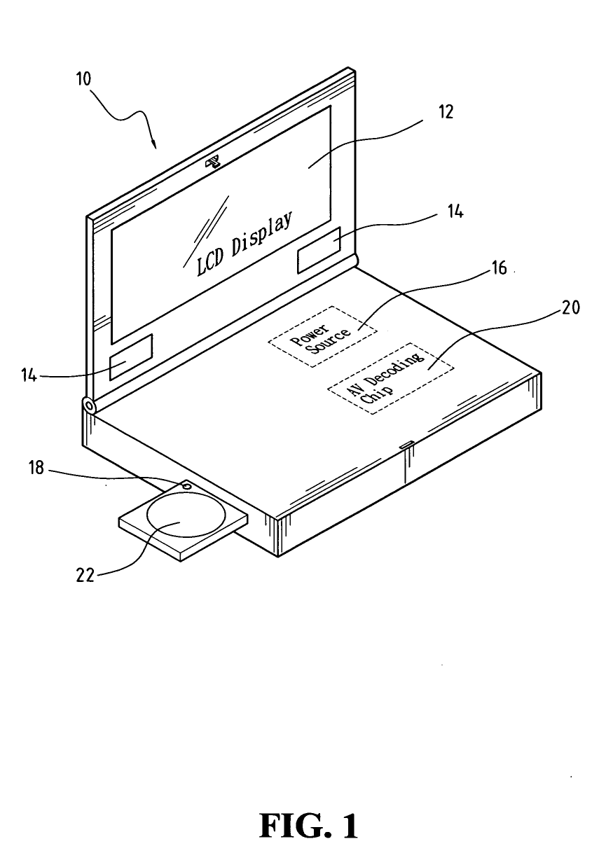

FIG. 1 is a schematic view of a preferred embodiment of the present invention. With reference to FIG. 1, the present invention includes an additionally added AV decoding chip 20 and the notebook computer 10's power source 16, LCD display 12, speaker 14, and laser disk drive 18.

The AV decoding chip 20 is a part of an AV processing circuit (not shown) that interconnects electrically the foregoing components and allows them to exchange information.

During the operation of the present invention, the power source 16 provides power only to the LCD display 12, speaker 14, laser disk drive 18, AV decoding chip 20, and the AV processing circuit, but not to the other components of the notebook computer 10, such as its CPU, chipset, memory, and those that are required by its operating system. The power source 16 obtains electricity from the mains or from a battery built in the notebook computer 10.

When the AV decoding chip 20 is ready, a user issues a “play” request to the device of the present invention and the AV decoding chip 20 would access the content of the AV CD 22 inside the laser disk drive 18, decode it, and play it out on the LCD display 12 and the speaker 14. The AV decoding chip 20 comprises a MPEG processor, a DSP (Digital Signal Processing) processor, and other processors that can access/process AV content. The AV CD 22 could be a DVD, VCD, or SVCD disk.

In summary, the device of the present invention turns a notebook computer, without its being powered on, into a portable AV player so that AV CD content could be conveniently and immediately played.

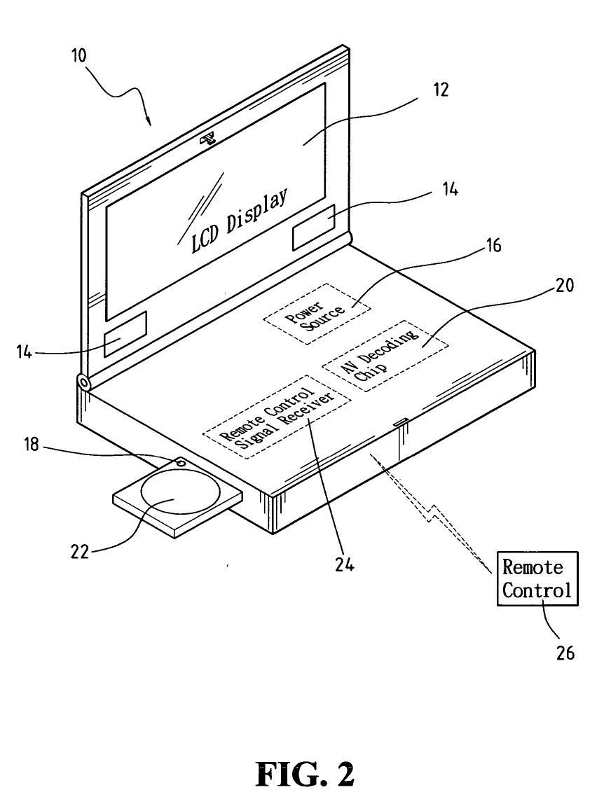

FIG. 2 is a schematic view of a remote control of a preferred embodiment of the present invention. As shown in FIG. 2, the notebook computer has an additional remote control signal receiver 24 installed inside for accepting control signals from a remote control 26. A user could use the control buttons (not shown) on the remote control 26 to send out corresponding control signals so that the playing of the AV CD 22 could be easily controlled. The control buttons comprise a power button, a play/pause button, a forward button, a backward button, a stop button, a fast forward button, and a fast backward button.

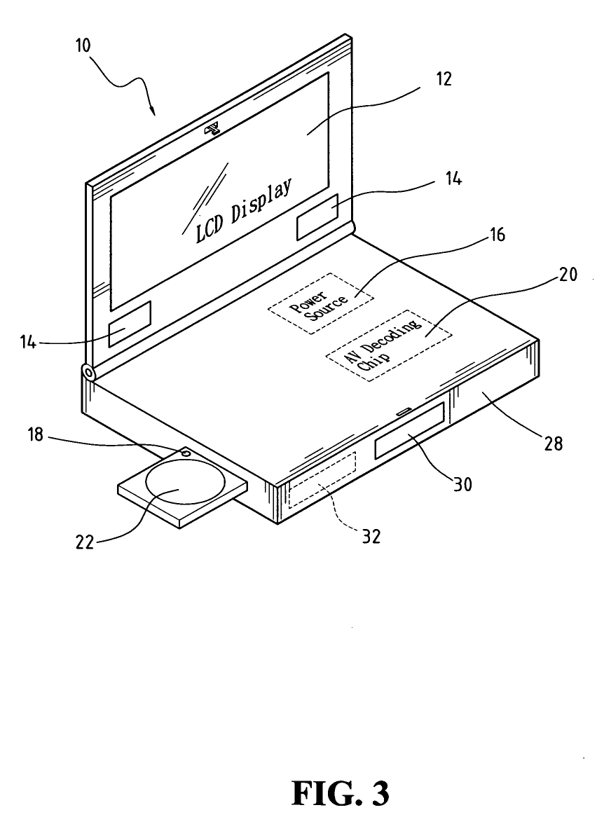

FIG. 3 is a schematic view of a control panel of a preferred embodiment of the present invention. As shown in FIG. 3, the notebook computer 10 has an additional control panel 28 on its casing for controlling the AV CD 22's playing. The control panel 28 has a display 30 for showing operation status and control buttons 32 identical to those on the remote control 26.

Using the control buttons 32 on the control panel 28, a user could easily controls the playing of the AV CD 22. In addition, the user could also easily get to know the operation status from the display 30.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device for directly playing AV CDs, said device installed in a notebook computer having at least a power source, a LCD display, a speaker, and a laser disk drive, said device characterized in that, without powering on said notebook computer, said device utilizes said power source to activate said LCD display, said speaker, said laser disk drive, and an AV processing circuit of said device, said AV processing circuit comprises an AV decoding chip, said AV decoding chip accesses, decodes, and plays an AV content stored on an AV CD in said laser disk drive out on said LCD display and said speaker.

2. The device according to claim 1, wherein said AV decoding chip comprises a MPEG processor, a DSP processor, and other processors that can access and process said AV content.

3. The device according to claim 1, wherein said AV CD is selected from the group comprising DVD, VCD, and SVCD.

4. The device according to claim 1, wherein said AV processing circuit, driven by said power source, interconnects electrically said LCD display, said speaker, said laser disk drive, and said AV decoding chip, and allows them to exchange information.

5. The device according to claim 1, wherein said notebook computer has a control panel located on said notebook computer's casing for controlling a playing of said AV content of said AV CD.

6. The device according to claim 1, wherein said notebook computer has a remote control signal receiver installed inside said notebook computer for accepting control signals from a remote control.

7. The device according to claim 5, wherein said control panel comprises the following control buttons: a power button, a play/pause button, a forward button, a backward button, a stop button, a fast forward button, and a fast backward button.

8. The device according to claim 6, wherein said remote control comprises the following control buttons: a power button, a play/pause button, a forward button, a backward button, a stop button, a fast forward button, and a fast backward button.

9. The device according to claim 5, wherein said control panel further comprises a display for showing operation status.
